(19) United States
(12) Patent Application Publication
(10) Pub. No.: US 2026/0023845 A1
(43) Pub. Date: Jan. 22, 2026

(54) GENERALIZING EXTENDED DETECTION AND RESPONSE EVENTS THROUGH VECTOR EMBEDDINGS

(71) Applicant: SentinelOne, Inc., Mountain View, CA (US)

(72) Inventors: Gal Braun, Tel Aviv (IL); Gal Abadi, Tel Aviv (IL); Dean Langsam, Naan (IL)

(21) Appl. No.: 19/275,338

(22) Filed: Jul. 21, 2025

Related U.S. Application Data
(60) Provisional application No. 63/673,429, filed on Jul. 19, 2024.

(51) Int. Cl. G06F 21/55

(52) U.S. Cl. CPC G06F 21/552; G06F 21/554

(57) ABSTRACT

The present disclosure relates to the analysis of computer system and network events for security applications. Some implementations relate to the generation of fixed-length embedding vectors to facilitate efficient analysis of large sets of data collected from monitoring tools such as extended detection and response (XDR) tools and endpoint detection and response (EDR) tools.

### CROSS-REFERENCE TO RELATED APPLICATIONS

This application claims priority to U.S. Provisional Application No. 63/673,429, filed Jul. 19, 2024, and titled “GENERALIZING EXTENDED DETECTION AND RESPONSE EVENTS THROUGH VECTOR EMBEDDINGS,” which is hereby incorporated by reference in its entirety.

### FIELD

The present disclosure relates to computer security, and in particular to the use of vector embeddings for generalizing extended detection and response events and other types of event monitoring data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Cybersecurity threats continue to evolve in complexity and sophistication, presenting ongoing challenges for organizations seeking to protect critical data and infrastructure. As the volume and variety of potential attack vectors increase, traditional security measures often struggle to keep pace with emerging threats. This has led to the development of more advanced monitoring and analysis tools, such as extended detection and response (XDR) systems.

XDR systems endeavor to provide a holistic view of an organization's security posture by collecting and correlating data from multiple sources such as endpoints (e.g., desktops, laptops, servers), network infrastructure, cloud environments, and so forth. These systems generate large volumes of event data. The event data can include information such as file system activities, networking connections, process executions, user behaviors, and so forth. While this wealth of data offers the potential for deep insights into security incidents, it also presents significant challenges in terms of efficient analysis and interpretation.

The sheer volume and heterogenous nature of security event data can make it difficult for analysts to identify and respond to genuine threats. False positives and benign activities often create noise that can obscure legitimate security issues. Additionally, sophisticated attackers may employee evasion techniques or carry out multi-stage attacks that are not easily detected when examining individual events in isolation or even when reviewing sets of events collected over hours or days.

Accordingly, there is a need for improved approaches to analyzing data captured by security platforms.

### SUMMARY

For purposes of this summary, certain aspects, advantages, and novel features are described herein. It is to be understood that not necessarily all such advantages may be achieved in accordance with any particular implementation. Thus, for example, those skilled in the art will recognize that the disclosures herein may be implemented or carried out in a manner that achieves one or more advantages taught herein without necessarily achieving other advantages as may be taught or suggested herein.

All of the implementations described herein are intended to be within the scope of the present disclosure. These and other implementations will be readily apparent to those skilled in the art from the following detailed description, having reference to the attached figures. The scope of the present disclosure is not intended to be limited to any particular disclosure implementation or implementations.

In some embodiments, the techniques described herein relate to a computer-implemented method for processing event data, the method including: accessing a plurality of events from one or more data sources, wherein the one or more data sources include at least one of extended detection and response (XDR) data, endpoint detection and response (EDR) data, or security information and event management (SIEM) data, determining an event type for each event of the plurality of events; determining, for each event of the plurality of events, an event encoder for the event, wherein the event encoder is determined using the determined event type; generating, for each event of the plurality of events using the determined event encoder, an event vector; generating an input to an event collection encoder, wherein the input is based on the generated event vectors; generating, using the event collection encoder and the input, an output embedding vector, wherein the output embedding vector is a fixed-length vector; and providing the output embedding vector to a processing head configured for one or more of: similarity detection, anomaly detection, classification, attribution, or prioritization.

In some embodiments, the techniques described herein relate to a computer-implemented method for processing event data, the method including: accessing a plurality of events from one or more data sources; determining an event type for each event of the plurality of events; generating an event vector for each event of the plurality of events, wherein each event vector is generated using an event encoder selected based on the event type of the event; generating an output embedding vector using an event collection encoder using the generated event vectors for each of the plurality of events.

In some embodiments, the techniques described herein relate to a computer-implemented method, wherein the plurality of events includes a file system event, wherein the file system event includes at least one of: a file read, a file deletion, a file creation, or a file update.

In some embodiments, the techniques described herein relate to a computer-implemented method, wherein the plurality of events includes a network event, wherein the network event includes an indication of one or more of: port number, destination, protocol, received traffic volume, or sent traffic volume.

In some embodiments, the techniques described herein relate to a computer-implemented method, wherein the one or more data sources include at least one of an endpoint detection and response (EDR) system, an extended detection and response (XDR) system, or a security information and event management (SIEM) system.

In some embodiments, the techniques described herein relate to a computer-implemented method, wherein the event collection encoder includes a machine learning model, wherein the machine learning model is trained to minimize a loss function, and wherein the loss function is one of mean squared error, cross-entropy, or reconstruction loss.

In some embodiments, the techniques described herein relate to a computer-implemented method, wherein the event collection encoder is configurable using one or more parameters, wherein the parameters are initialized randomly or using pre-trained weights.

In some embodiments, the techniques described herein relate to a computer-implemented method, wherein the event collection encoder includes a multi-level encoder.

In some embodiments, the techniques described herein relate to a computer-implemented method, wherein each event encoder is configured to generate embeddings having a fixed size.

In some embodiments, the techniques described herein relate to a computer-implemented method, wherein the event collection encoder is configured to generate output embedding vectors with a fixed size.

In some embodiments, the techniques described herein relate to a computer-implemented method, further including: identifying a plurality of similar events from the plurality of events; and dropping a first subset of the plurality of similar events, wherein the first subset is not used for generating event vectors or for generating the output embedding vector.

In some embodiments, the techniques described herein relate to a computer-implemented method, wherein the similar events include network events, and wherein the similar events are determined based on a common IP address and port.

In some embodiments, the techniques described herein relate to a computer-implemented method, further including providing the output embedding vector to a processing head, wherein the processing head includes a program configured for one or more of: similarity determination, anomaly detection, classification as malicious or benign, attribution, or prioritization.

In some embodiments, the techniques described herein relate to a system for processing event data, the system including: at least one processor; and at least one non-transitory, computer-readable storage medium storing instructions that, when executed by the at least one processor, cause the system to: access a plurality of events from one or more data sources; determine an event type for each event of the plurality of events; generate an event vector for each event of the plurality of events, wherein each event vector is generated using an event encoder selected based on the event type of the event; generate an output embedding vector using an event collection encoder using the generated event vectors for each of the plurality of events.

In some embodiments, the techniques described herein relate to a system, wherein the one or more data sources include at least one of an endpoint detection and response (EDR) system, an extended detection and response (XDR) system, or a security information and event management (SIEM) system.

In some embodiments, the techniques described herein relate to a system, wherein the event collection encoder includes a machine learning model, wherein the machine learning model is trained to minimize a loss function, and wherein the loss function is one of mean squared error, cross-entropy, or reconstruction loss.

In some embodiments, the techniques described herein relate to a system, wherein the event collection encoder is configurable using one or more parameters, wherein the parameters are initialized randomly or using pre-trained weights.

In some embodiments, the techniques described herein relate to a system, wherein the instructions are further configured to cause the system to: identify a plurality of similar events from the plurality of events; and drop a first subset of the plurality of similar events, wherein the first subset is not used for generating event vectors or for generating the output embedding vector.

In some embodiments, the techniques described herein relate to a system, wherein the similar events include network events, and wherein the similar events are determined based on a common IP address and port.

In some embodiments, the techniques described herein relate to a system, wherein the instructions are further configured to cause the system to provide the output embedding vector to a processing head, wherein the processing head includes a program configured for one or more of: similarity determination, anomaly detection, classification as malicious or benign, attribution, or prioritization.

### BRIEF DESCRIPTION OF THE DRAWINGS

Detailed descriptions of implementations of the present invention will be described and explained through the use of the accompanying drawings.

FIG. 1 is a diagram that illustrates an example process according to some implementations of the present disclosure.

FIG. 2 is a diagram that illustrates an example process according to some implementations of the present disclosure.

FIG. 3 is a diagram that illustrates an example process according to some implementations of the present disclosure.

FIG. 4 illustrates an example of clustering according to some implementations.

FIG. 5 is a block diagram of a security analytics system according to some implementations.

FIG. 6 is a block diagram depicting an embodiment of a computer hardware system configured to run software for implementing one or more of the systems and methods described herein.

The technologies described herein will become more apparent to those skilled in the art from studying the Detailed Description in conjunction with the drawings. Embodiments or implementations describing various aspects are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Although several implementations, examples, and illustrations are disclosed below, it will be understood by those of ordinary skill in the art that the scope of the present disclosure extends beyond the specifically disclosed implementations, examples, and illustrations and includes other uses of the inventions and obvious modifications and equivalents thereof. Implementations are described with reference to the accompanying figures, wherein like numerals refer to like elements throughout. The terminology used in the description presented herein is not intended to be interpreted in any limited or restrictive manner simply because it is being used in conjunction with a detailed description of certain specific implementations. In addition, implementations can comprise several novel features and no single feature is essential or solely responsible for its desirable attributes.

Analyzing limited data such as single events or a small number of closely related events can be relatively straightforward. For example, if a person uses their credit card in an unexpected location (e.g., in another state or country), makes a very large transaction, or makes a very small transaction (which can indicate, for example, that someone is checking if the card works), such a transaction can be detected as unusual and declined, flagged for further review, flagged for confirmation by the cardholder, etc. However, if fraud is being committed through a larger chain of transactions (e.g., using various banks, credit cards, etc.), it can be difficult to detect such activity. As another example, a social engineering attack in which an outsider calls a business and immediately asks for sensitive information without establishing a rapport is likely to be detected, whereas a social engineering attack in which the outsider does advance research about the business and builds a rapport through multiple calls or emails over the course of days, weeks, or months, possibly posing as multiple different people, may be more likely to go undetected and succeed in obtaining the sensitive information.

In the context of cybersecurity, incidents are often complex and can involve many actions, making them difficult to detect and analyze. For example, an attacker may utilize multiple servers, multiple protocols, multiple exploits, and so forth when carrying out an attack, may carry out an attack over a long period of time, and so forth. Some sophisticated attacks utilize advanced detection evasion techniques, such as detecting when they are running in a sandbox or virtual machine and modifying their behavior accordingly, utilizing dormancy periods, and so forth, making detection more challenging.

Endpoint detection and response (EDR), extended detection and response (XDR), Security Information and Event Management (SIEM), and other monitoring approaches can provide valuable information about threat activity that occurs on computer systems. While reference is made to particular monitoring approaches or tools within the specification, it will be readily appreciated that, unless context clearly dictates otherwise, the discussion is not limited to any particular monitoring approach or monitoring tool.

Extracting useful insights from monitoring data can be a daunting task. For example, an EDR solution can collect data from diverse data sources, such as desktops, laptops, servers, tablets, smartphones, and so forth. Each endpoint can generate a large amount of data, which can exist in diverse formats and structures. The sheer volume of EDR and similar data can make analysis computationally impractical. In many cases, much the data may be benign, with legitimate threats easily getting lost in the noise of benign activity. Moreover, different types of devices may exhibit different baseline activity. Different users may also engage in different baseline activity.

SIEM, EDR, XDR, and similar data are commonly used for detecting and responding to cybersecurity threats such as malware, ransomware, insider threats, advanced persistent threats, and so forth. Cybersecurity threats can be sophisticated and can, for example, employ evasion techniques, polymorphic malware, and so forth, which can make threats difficult to detect and can require analyzing a large volume of data to uncover. SIEM, EDR, XDR, and similar solutions can have significant noise in the information they collect or the behaviors they detect, such as detecting false positives, benign activities, and so forth. Distinguishing between real threats and false positives can be challenging and can benefit from context-aware analysis, which can involve analyzing events not in isolation but in the larger context of behaviors occurring on a device, network, etc.

Monitoring solutions can generate large numbers of alerts. Security operations center (SOC) analysts, threat intelligence analysts, and others (generally, analysts) often need to manually investigate alerts to determine if they are actual threats or not. If there is an actual threat, analysts can manually investigate to identify, for example, which malware family a threat belongs to. This can involve extensive data analysis, cross-referencing of threat indicators, consulting multiple intelligence sources, and so forth, making the process time-consuming and prone to errors. Accordingly, there is a need for approaches that enable analysis that is faster, more reliable, and so forth. Moreover, as described herein, in many cases, threats may only become evident with the analysis of large volumes of events in aggregate, rather than the analysis of single events in isolation.

Machine learning and artificial intelligence (generally, machine learning) techniques can be used for enhanced analysis of event data. Machine learning techniques can be used to uncover patterns and/or anomalies that might be missed by many other systems, such as rules-based systems. However, applying machine learning techniques to security event data presents its own set of challenges, including the need to handle both structured and unstructured data, account for temporal relationships between events, and adapt to the changing nature of both normal behavior and attack techniques.

In some implementations, a machine learning model (e.g., a deep learning model) is designed to improve cyber security threat analysis and response. In some implementations, multiple machine learning models (e.g., multiple deep learning models) are used. These models can process and analyze collections of objects/events extracted from an endpoint detection and response (EDR) system or a similar system, such as an extended detection and response (XDR) system, SIEM system, or any other monitoring or data collection software.

Utilizing one or more machine learning models for analysis can involve vectorizing inputs (e.g., events, event sequences, data objects, etc.). Machine learning-based approaches can become time-consuming, inefficient, and costly when the event/object data from EDR, XDR, SIEM, or other systems are directly vectorized to train the models, because such resulting vectors typically have high dimensionality. Accordingly, efficient use of such models can depend upon the specific vectorization and training approaches used.

An event collection can refer to a group of related events. For example, an event collection can include information about related processes, files, threads, events, network activity, and/or other data. An event collection can include a plurality of objects. In some implementations, an event collection is a time-based collection. The use of event collections can enable more efficient and/or effective analysis of monitoring data.

In many cases, the volume of data collected for events is immense in order to adequately cover the attack surface of a protected environment. Event data can be correlated or assigned by EDR, XDR, SIEM, or any combination thereof into event types, such as network activity, kernel activity, incident finding, etc., for various cybersecurity applications such as threat identification, hunting, visibility, and automation. In some implementations, such software may itself correlate event data. In some implementations, other software may be used to correlate event data. Due to the variety of purposes the events serve and the breadth of data collection needed to detect malicious actions, events can be very complex with a multitude of features. In the context of machine learning, this can lead to vectors with high dimensionality. High dimensionality presents several challenges for machine learning models, such as increased computational complexity, the curse of dimensionality, in which data becomes sparse as the volume of a vector space increases, making it difficult to find meaningful patterns, risk of overfitting, and so forth.

An embedding is a type of vector that can be used to represent complex objects, such as event data created by EDR, XDR, and SIEM systems. Embeddings can reduce dimensionality and allow for clustering, semantic representation, etc., as well as enabling simpler models. By transforming the event collection objects into compact embeddings based on event types, the approaches herein can enable the creation of a versatile and scalable platform for various cybersecurity applications.

In some implementations, the approaches described herein can enable cybersecurity analysts and/or detection teams to leverage the power of deep learning in their threat analysis and response efforts. For example, a system can utilize the technologies described herein for automatic event data processing, analysis, or both. By abstracting complex event collection data into concise embedding vectors, the approaches herein can facilitate the development of diverse applications with minimal data requirements, developer technical expertise, and/or the like. In some implementations, the approaches described herein can enhance the speed and/or accuracy of threat detection, threat classification, and so forth. In some implementations, the approaches described herein can enable proactive mitigation strategies and/or informed decision-making across various security domains. The integration of these tools can automate much of the once manual data correlation and analysis, resulting in decreased Mean Time to Respond (MTTR) and expediting the research process. The approaches herein can enhance detection accuracy and allow analysts to focus on higher-priority tasks, thereby improving overall efficiency and security. Moreover, the approaches described herein can enable more complex analysis than would be possible with manual investigation.

In some implementations, the approaches described herein can offer one or more benefits to developers. For example, in some implementations, the approaches herein can be used to streamline artificial intelligence/machine learning (AI/ML) application development by providing embedding vectors, which can reduce development time and/or effort, reduce or eliminate the need to rely on raw data (e.g., raw EDR or XDR data), and so forth. In some implementations, the approaches herein can provide a standardized representation of cybersecurity event collection objects, which can help to enable integration and/or adaptation to evolving use cases. In some implementations, consistent data representation can enable easier interoperability across applications. In some implementations, the approaches described herein can enable developers to tailor applications to specific needs more easily, which can foster innovation in threat analysis and response within the cyber security domain. For example, while the embeddings described herein and the processes for generating such embeddings aim to provide compact structures, these structures can represent dense, rich, complex data in an efficient, consistent manner, enabling complex analysis.

In some implementations, the approaches herein can be used for various applications such as, for example and without limitation: threat classification (e.g., categorizing threats by learning patterns and anomalies within objects, which can facilitate fast and accurate threat identification); false positive/true positive analysis (e.g., distinguishing between false positives and true positives by discerning subtle nuances within data and comparing them to previously analyzed and labeled data); similarity (e.g., measuring similarity between objects, which can provide insights into recurring patterns and/or potential correlations across security incidents), explainability (e.g., translating complex data into human-readable explanations, which can enhance understanding and/or facilitate informed decision-making for security analysts); and/or alert prioritization (e.g., prioritizing security alerts based on severity and/or relevance of underlying objects, which can enable efficient resource allocation and/or response prioritization). These are merely examples, and it will be appreciated that the approaches described herein can have other uses.

Some conventional approaches can rely on manually engineered features. However, manual feature engineering can require significant expertise and can be difficult to carry out. In some implementations, the approaches herein can automate feature engineering using neural networks. For example, rather than relying on handcrafted features, in some implementations, a model can learn to extract meaningful features directly from event collection objects, which can reduce or eliminate the need for manual intervention. This approach can save time and resources, as well as provide better information as there is no reliance on manual selection or feature engineering that requires in-depth knowledge which can quickly become stale. In some implementations, such approaches as described herein can enhance the model's ability to discern complex patterns and relationships within the data. In some implementations, by dynamically adjusting to evolving threat landscapes, the approaches herein can enable scalable and adaptable threat analysis and response capabilities.

### Vector Encoding to Create Embeddings

In some implementations, event collections can be represented as tabular data. In some implementations, event collections can be represented in a graph. Any representation can be used, and in some implementations, representations can undergo one or more transformations to convert them into a format for use in the systems and methods described herein.

Different types of events, which can be grouped by an SIEM, XDR, EDR, or similar system or other software, can have certain similarities but can also have significant differences. For example, events can be grouped by attack path or threat actor. Different attack paths performed by the same threat actor may share similar patterns, such as the same malicious actions taken across multiple attacks. Events themselves may also have similarities or differences. For example, a file system activity event and a network activity event can both be classified as severe security events. However, both types of events differ in significant ways. For example, a file may be read, deleted, created, or updated, whereas a network event can include indications of whether a connection is open, closed, etc. In some cases, network event data can include information such as IP address, port number, volume of data transferred out, volume of data received, and so forth.

A vector can be a representation of input data (e.g., event data) in the form of a matrix or tensor. The vector can be further compressed from a high-dimensional tensor (matrix) to a single-dimensional vector, also referred to as a latent space representation embedding. Embedding involves transforming high-dimensional data into informationally dense low-dimensional vectors that can be used for various machine learning tasks.

In some implementations, an encoder can be trained by incorporating the encoder into a larger neural network architecture and optimizing its parameters to learn meaningful representations of the input data to create an embedding. While various approaches can be used, typically, an encoder can have one or more parameters. The parameters can be initialized randomly, using pre-trained weights, or otherwise. During a forward pass, the training data can be passed through the encoder to obtain vector representations. A loss function (e.g., mean squared error for regression tasks, category cross-entropy for classification tasks, or reconstruction loss for autoencoder tasks) can be used to characterize a difference between output data and the original input data (or labels assigned to the input data). The model parameters can then be updated to minimize the loss function. Gradients of the loss function can be computed with respect to model parameters, and model parameters can be adjusted accordingly (e.g., directionally opposite the gradients). Passing the training data through the encoder, computing the loss function, and adjusting the weights can be performed iteratively, for example, for a defined number of iterations or until another condition is met, for example until a loss function output reaches a threshold value.

Typically, encoders are limited in the types of input information they can compress into vectors. For example, an encoder trained to generate vectors representing portrait photos of people may perform poorly when used with inputs of, for example, landscape photos. As another example, an encoder trained using English text may perform poorly when presented with text in Spanish and may perform even more poorly when presented with text in a language that does not follow the subject-verb-object order typical of English. Accordingly, different encoders may be used for different types of information.

Various architectures can be used for encoders, such as recurrent neural networks (RNNs), long short-term memory networks (LSTMs), or transformer-based architectures such as bidirectional encoder representations from transformers (BERT) or generative pre-trained transformers (GPT).

In some implementations, the approaches herein can use a plurality of encoders, and each encoder can be trained to process a particular type or types of data. For example, an event collection may include file operations (e.g., read, write, modify, create, delete), network operations, process execution or termination operations, privilege escalation operations, system configuration operations, and so forth. The types of information associated with different types of events can vary; thus, in some implementations, it can be advantageous to use a plurality of encoders, each encoder configured to generate vector representations of one or more specific types of events.

Various encoder implementations can be used in different implementations. For example, in some implementations, an encoder can be a single-layer encoder. In some implementations, an encoder can include multiple layers, which can reduce computational costs, decrease the amount of training data needed, and/or yield better compression than single-layer encoders.

In some implementations, encoders can be configured to output vectors of a fixed size, regardless of the size of the input data. For example, an event collection with a large number of events can have a vector representation that is the same length as a vector for an event collection having a small number of events.

In some cases, there can be a large number of similar events. For example, if a computer system is infected with file-encrypting ransomware, there can be a large number of file writing events corresponding to a large number of files that are being encrypted by the ransomware. In some implementations, such repeat operations can be represented as an average or other simplified or summary representation. In some implementations, an encoder can be configured to drop certain events. For example, if an encoder has already encountered five network accesses to a particular IP address and port, there may be little value in including additional accesses to the same IP address and port in the vector representation. In some implementations, the encoder stops processing similar events beyond a threshold number of similar events. In some implementations, a preprocessing algorithm identifies similar events and drops events that exceed the threshold. In some implementations, thresholds are not used, and events are not dropped. This can be beneficial, for example, to more fully understand the scope of an attack.

In some implementations, malicious operations can be halted. For example, anti-malware software may stop ransomware after only a relatively small number of files are encrypted. This can lead to difficulty in analyzing events. However, rich vectors can enable insightful analysis even when malicious operations are interrupted, as there can still be enough data to analyze the malicious event.

In some implementations, a system can provide an application programming interface (API) that enables users, developers, and so forth to utilize the functionality described herein. Such an API can enable others to develop applications that take advantage of the approaches described herein.

In some implementations, a system can implement a gradient boosting model, such as provided by the XGBoost framework. In some implementations, a system can provide a dimensionality reduction algorithm, which can simplify vector outputs. Dimensionality reduction can result in some data loss, but can offer some advantages because, for example, vectors can be simpler and less important features may be dropped. In some cases, dimensionality reduction can result in improved performance, reduced computational demand, and so forth. In some implementations, a system can use, for example, a k-nearest neighbors algorithm to identify similar threat actors, similar malware, and/or the like.

The approaches described herein provide a number of improvements to the functioning of computers both generally and in the context of cybersecurity data processing and analysis. For example, the vector embedding approach described herein can substantially improve computational efficiency as compared with many other analysis methods. By converting heterogenous event data into standardized vector representations, a system can reduce the computational overhead associated with processing data in diverse formats. Many other systems may need to apply different parsing and analysis algorithms to each type of event data, whereas the present disclosure enables analysis using vector encodings.

In some implementations, an event collection can enhance efficiency by generating fixed-size vector representations regardless of the number or complexity of input events. This standardization can enable more predictable memory usage and processing times, enabling better resource allocation and system optimization. The fixed-size vector embeddings can also facilitate certain batch processing operations.

In some implementations, the systems and methods herein can significantly improve the functioning of computer systems via data simplification. As described herein, XDR and other security monitoring systems can generate large volumes of heterogeneous data from multiple sources. This data can exist in various formats, structures, and schemas, creating substantial challenges for analysis. The disclosed vector embedding approaches herein can transform complex data into more manageable vector representations. By encoding events into vectors (e.g., vectors within a high-dimensional space), a system can capture relationships and patterns within data, while reducing overall complexity. This transformation can enable a computer system to process data more efficiently, for example because vector operations are typically well-optimized and systems can leverage specialized hardware such as graphics processing units (GPUs), tensor processing units (TPUs), and so forth.

In some implementations, the approaches herein can improve memory utilization. For example, a system can drop redundant events, such as multiple network accesses to the same IP address and port after a defined threshold. Selective processing of data can reduce memory requirements and/or decrease processing times while preserving the most significant information for analysis.

In some implementations, the hierarchical encoding structure described herein, in which individual events are first encoded into event vectors and then aggregated into event collection vectors, may enable more efficient memory management. For example, rather than maintaining large collections of raw event data in memory, a system can work with compact vector representations of a limited set of data, which can significantly reduce the memory footprint.

In some implementations, the approaches described herein can improve computational scalability through parallelization. For example, different encoders can process different events simultaneously. This parallel processing can better utilize multi-core architectures, distributed computing environments, and so forth.

The vector-based analysis can enable more efficient similarity comparisons. For example, string-based or rule-based comparisons can involve complex parsing and matching algorithms, while vector similarity can be evaluated using simple mathematical operations such as cosine similarity, L1 distance, and L2 distance.

In some implementations, the approaches herein can improve input/output efficiency, for example network efficiency. For example, the approaches herein can reduce the amount of data that needs to be transmitted and stored. As an example, instead of transferring and storing large volumes of raw event data, systems can instead, in some implementations, transfer vector representations, which typically can be smaller than raw event data.

### Clustering & Classification

Conventional signature-based detection methods are often insufficient for identifying novel or polymorphic threats. Moreover, conventional signature-based malware detection does not help when attackers do not rely on specific malware to achieve their goals. Additionally, even when malware is used, the specific malware may be unknown or may be a variant of known malware that cannot be readily detected using signature-based methods.

Clustering is an unsupervised machine learning methods used to group unlabeled data points based on similarities. In the context of cybersecurity, clustering can be used to perform large-scale anomaly detection by identifying deviations from established baselines of normal system and/or network activity. By processing data from EDR, XDR, SIEM, and/or the like, clustering algorithms can isolate statistically significant groupings of events that may indicate coordinated malicious activity.

A significant advantage of clustering is the ability to detect threats and attacks without a priori knowledge. Benign activities can form large, dense clusters representing normal operational patterns. Malicious activities can appear as smaller, distinct clusters. These smaller clusters can correspond to different attack vectors, malware types, and so forth. For example, one cluster may represent variants of a first ransomware program, while another cluster can represent variants of a different ransomware program.

While malware may be difficult to identify from static signatures, which can vary across versions, variants, and so forth, malware within a particular family typically exhibits consistent operational behavior. Clustering based on behavioral data, such as from EDR logs, XDR logs, and the like, can enable grouping of disparate malware samples that share a common behavioral profile. Such log data can include, for example, API call sequences, process lineage, file system interactions, network communications patterns, and so forth.

Logged data for behavioral clustering can include, for example, process execution data (e.g., parent-child process relationships, command line arguments, process injection events), file system activity (e.g., file creation, file modification, file deletion, target directory location), network telemetry (e.g., periodicity, target, protocol usage, payload size), and/or system call activity (e.g., create file calls, set registry value calls, create remote thread calls).

A new malware variant exhibiting behavioral markers consistent with a known malware family, for example, can be grouped into a pre-existing cluster for that malware, thereby enabling the identification of the malware even in the absence of a matching file signature.

In some implementations, a system is configured to utilize k-means clustering to assign data points into a predefined number (k, where k is a natural number) of clusters. Other clustering algorithms can be used additionally or alternatively. For example, Density-Based Spatial Clustering of Applications with Noise (DBSCAN) is a density-based algorithm that can be used to identify arbitrarily shaped clusters and can be effective for separating sparse, anomalous event sequences from dense clusters of benign activity. As another example, hierarchical cluster can be used to produce a dendrogram with various levels of granularity. Such a clustering approach can be beneficial for understanding the relationships between different subgroups of suspicious activity.

In some implementations, clusters are not labeled. That is, data can be clustered, but labels may not be assigned to the clusters. In some implementations, classification is applied to determine labels for data. Classification is a supervised machine learning process that uses labeled data to train a model to categorize new, unlabeled data points. In a security context, this can facilitate the attribution of an attack to a specific malware family, a specific adversary, etc. In some implementations, classification is used to identify a threat type, such as ransomware, credential harvesting, etc.

Identifying threat actors can be significant. For example, a state-sponsored attacker may present a significantly bigger risk than a solo attacker. Different threat actors tend to behave in different ways. Thus, for example, threat actor attribution can help to identify an adversary's next moves. For example, different advanced persistent threat (APT) groups and cybercriminal organizations utilize distinct tactics, techniques, and procedures (TTPs), which can appear as discernible patterns in monitoring data.

A classification model can be trained on features extracted from logs associated with previously attributed attacks. Such features can include, for example, infrastructure indicators (e.g., specific IP address ranges, domains for command-and-control infrastructure, autonomous system numbers), temporal analysis (e.g., operational activity confined to particular hours, which may indicate location/time zone), tooling and malware (e.g., consistent use of custom malware families, penetration testing tools, exploits), behavior TTPs (e.g., preferred methods for initial access (e.g., phishing lure themes), lateral movement (e.g., PsExec vs. Windows Management Instrumentation (WMI)), data exfiltration (e.g., DNS tunneling)).

### Example Implementations

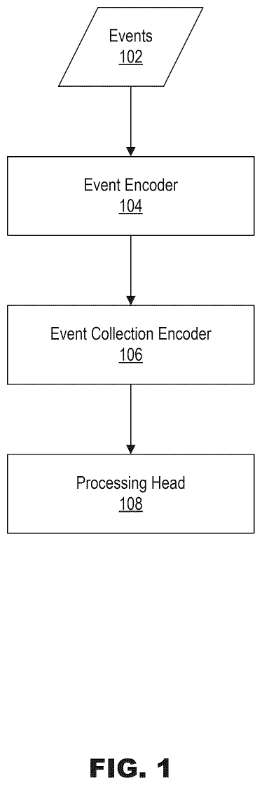

FIG. 1 is a diagram that illustrates an example process according to some implementations of the present disclosure. An event encoder 104 can receive events 102 and encode the events into a plurality of vectors. The event collection encoder 106 can receive the vectors and encode them into a single vector representing the events. The output of the event collection encoder 106 can be provided to a processing head 108 for further analysis, such as determining if activity, software, etc., is malicious or benign, analyzing the events that took place within an event collection, determining attribution, clustering events and/or event collections, and so forth. In some implementations, the output of the event collection encoder can be used to summarize an event collection.

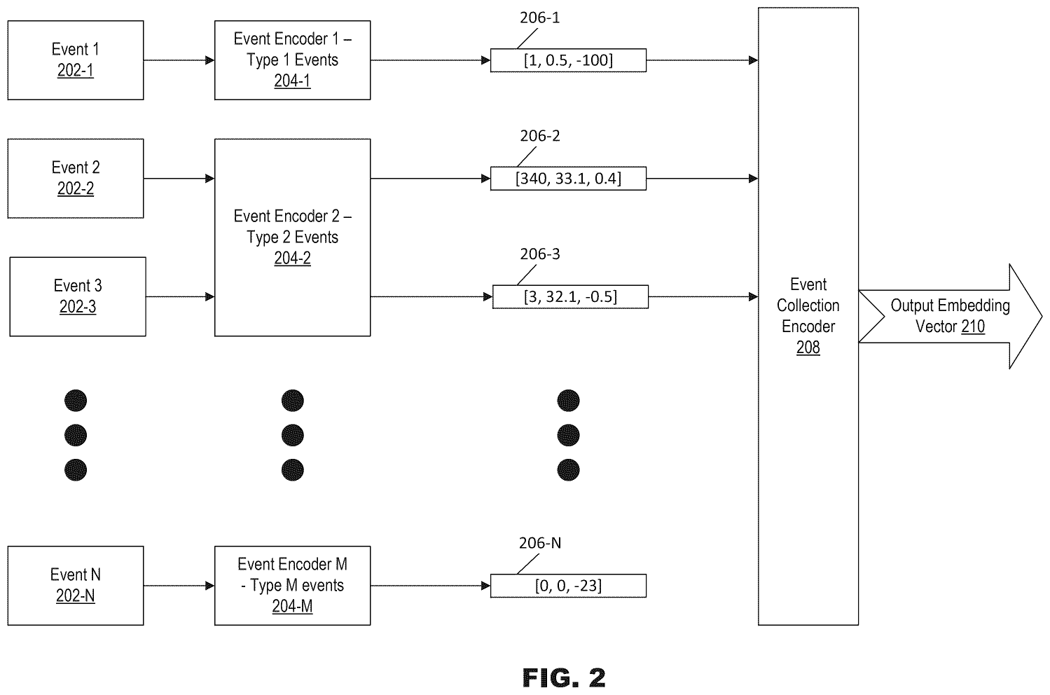

FIG. 2 is a diagram that illustrates an example process according to some implementations of the present disclosure. A plurality of events (e.g., a plurality of events for an event collection) 202-1-202-N (collectively, events 202) can each be provided to a corresponding event encoder 204-1-204-M (collectively encoders 204), which can output an embedding vector for a single application or multiple applications, or multiple embedding vectors for multiple applications. In some implementations, the event encoders can be the same encoder or can be different encoders. For example, different encoders can be used for different types of events. The event vectors can then be provided to an event collection encoder, which can output a single vector for each set of events provided to the event collection encoder. As shown in FIG. 2, the same encoder can be used for different events of the same type. For example, in FIG. 2, Event 1 202-1 is a Type 1 event and is encoded by Event Encoder 1 204-1. Event 2 and Event 3 are each Type 2 events and are each encoded by Event Encoder 2 204-2. Event N 202-N is a Type M event and is encoded by Event Encoder M 204-M. In general, the number of event encoders can be different from, and typically smaller than, the number of events (e.g., in general, M<=N). While FIG. 2 shows a plurality of events and a plurality of event encoders, the number of events and number of event encoders can be any natural number, included one. For example, multiple events may have the same event type and can be encoded by the same encoder. The encoders 204 can output vectors 206-1-206-N (collectively, vectors 206). The vectors 206 can be provided to an event collection encoder 208, which can output an embedding vector 210.

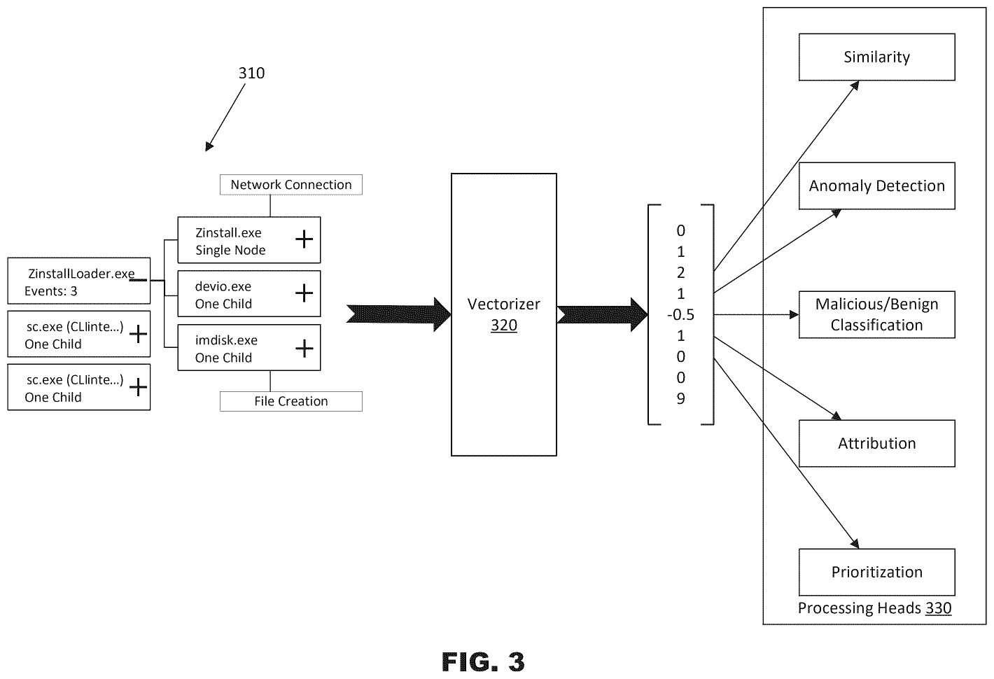

FIG. 3 is a diagram that illustrates an example process according to some implementations of the present disclosure. Event data 310, which can be hierarchical in some implementations, can be vectorized by a vectorizer 320, and the outputs of the vectorizer 320 can be provided to a machine learning model for further analysis. The vectorizer 320 operates as shown in and described in relation to FIG. 2 in some implementations. The vectors can be used to create models, for example, models that determine event collection similarity, detect anomalies, classify software as malicious or benign, determine attribution for malicious activity, prioritize remediation measures, and/or the like.

In some implementations, a user can input a single event collection into a model. In some implementations, a user can input multiple event collections into the model. Single event collection input may be used, for example, in applications where a summary of an event collection is desired or where further investigation of the event collection is desired. Multiple inputs can be used, for example, when comparisons, prioritization, and/or the like are desired.

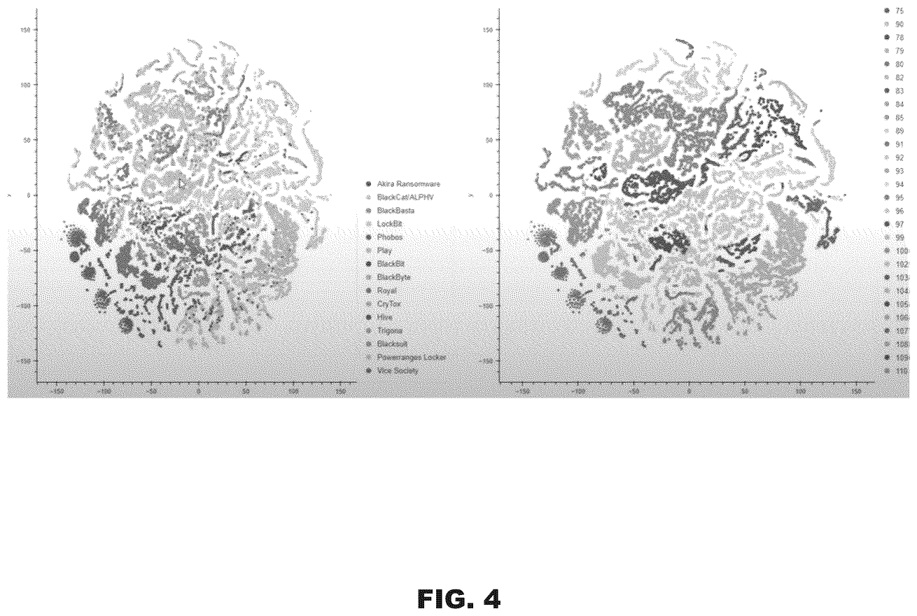

FIG. 4 illustrates an example of clustering according to some implementations. In FIG. 4, ransomware is clustered based on similarity. In some implementations, the approaches described herein are used to process events and event collections for analysis. A processing head can be configured for ransomware clustering.

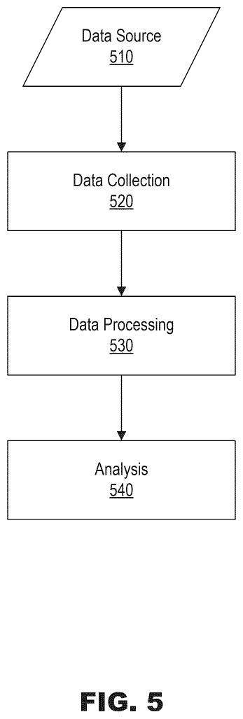

FIG. 5 is a block diagram of a security analytics system according to some implementations. A data collection module 520 can collect information from one or more data sources 510. The data collection module can include one or more of an agent installed on an endpoint, a collector installed within a network, and so forth. The security analytics system can include a data processing module 530 that can process the data collected by the data collection module 520. Processing the data can include, for example, normalization, aggregation, enrichment, and so forth. In some cases, the data processing module 530 can be configured to carry out extract, transform, load (ETL) operations to convert and store data in a different format. An analysis module 540 can be configured to analyze the processed data to determine cybersecurity events, categorize events, aggregate events, and so forth. For example, the analysis module 540 can aggregate related events.

### Computer System

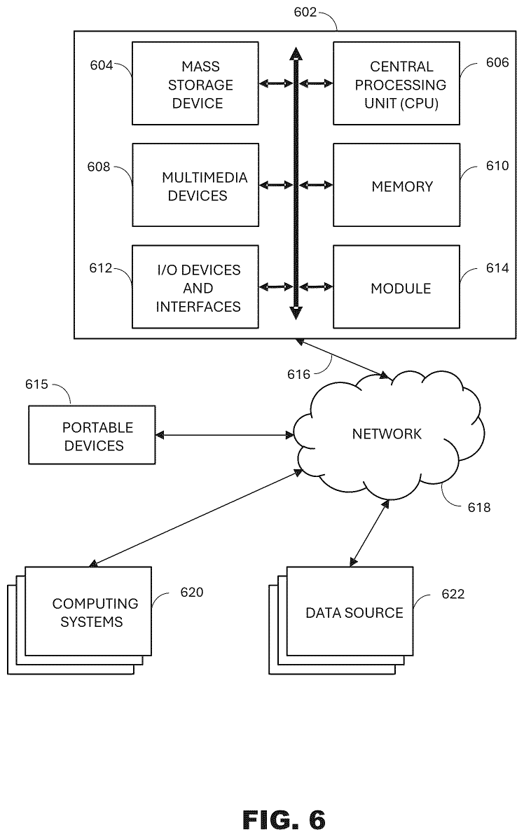

FIG. 6 is a block diagram depicting an embodiment of a computer hardware system 602 configured to run software for implementing one or more of the systems and methods described herein. The example computer system 602 is in communication with one or more computing systems 620 and/or one or more data sources 622 via one or more networks 618. While FIG. 6 illustrates an embodiment of a computing system 602, it is recognized that the functionality provided for in the components and modules of computer system 602 may be combined into fewer components and modules, or further separated into additional components and modules.

The computer system 602 can comprise a module 614 that carries out the functions, methods, acts, and/or processes described herein. The module 614 is executed on the computer system 602 by a central processing unit 606 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, Lua, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within specially designed hardware or firmware. Not all calculations, analysis, and/or optimization require the use of computer systems, though any of the above-described methods, calculations, processes, or analyses may be facilitated through the use of computers. Further, in some implementations, process blocks described herein may be altered, rearranged, combined, and/or omitted.

The computer system 602 includes one or more processing units (CPU) 606, which may comprise a microprocessor. The computer system 602 further includes a physical memory 610, such as random-access memory (RAM) for temporary storage of information, a read only memory (ROM) for permanent storage of information, and a mass storage device 604, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 602 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 602 includes one or more input/output (I/O) devices and interfaces 612, such as a keyboard, mouse, touch pad, and printer. The I/O devices and interfaces 612 can include one or more display devices, such as a monitor, which allows the visual presentation of data to a user. More particularly, a display device provides for the presentation of GUIs as application software data, and multi-media presentations, for example. The I/O devices and interfaces 612 can also provide a communications interface to various external devices. The computer system 602 may comprise one or more multi-media devices 608, such as speakers, video cards, graphics accelerators, and microphones, for example.

The computer system 602 may run on a variety of computing devices, such as a server, a Windows server, a Structure Query Language server, a Unix Server, a personal computer, a laptop computer, and so forth. In other implementations, the computer system 602 may run on a cluster computer system, a mainframe computer system and/or other computing system suitable for controlling and/or communicating with large databases, performing high volume transaction processing, and generating reports from large databases. The computing system 602 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 602 illustrated in FIG. 6 is coupled to a network 618, such as a LAN, WAN, or the Internet via a communication link 616 (wired, wireless, or a combination thereof). Network 618 communicates with various computing devices and/or other electronic devices, such as portable devices 615. Network 618 is communicating with one or more computing systems 620 and one or more data sources 622. The module 614 may access or may be accessed by computing systems 620 and/or data sources 622 through a web-enabled user access point. Connections may be a direct physical connection, a virtual connection, and other connection type. The web-enabled user access point may comprise a browser module that uses text, graphics, audio, video, and other media to present data and to allow interaction with data via the network 618.

Access to the module 614 of the computer system 602 by computing systems 620 and/or by data sources 622 may be through a web-enabled user access point such as the computing systems' 620 or data source's 622 personal computer, cellular phone, smartphone, laptop, tablet computer, e-reader device, audio player, or another device capable of connecting to the network 618. Such a device may have a browser module that is implemented as a module that uses text, graphics, audio, video, and other media to present data and to allow interaction with data via the network 618.

The output module may be implemented as a combination of an all-points addressable display such as a cathode ray tube (CRT), a liquid crystal display (LCD), a plasma display, or other types and/or combinations of displays. The output module may be implemented to communicate with interfaces 612 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some implementations, the system 602 may comprise a physical or logical connection established between a remote microprocessor and a mainframe host computer for the express purpose of uploading, downloading, or viewing interactive data and databases on-line in real time. The remote microprocessor may be operated by an entity operating the computer system 602, including the client server systems or the main server system, an/or may be operated by one or more of the data sources 622 and/or one or more of the computing systems 620. In some implementations, terminal emulation software may be used on the microprocessor for participating in the micro-mainframe link.

In some implementations, computing systems 620 who are internal to an entity operating the computer system 602 may access the module 614 internally as an application or process run by the CPU 606.

In some implementations, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the creator. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 602 may include one or more internal and/or external data sources (for example, data sources 622). In some implementations, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 602 may also access one or more databases 622. The databases 622 may be stored in a database or data repository. The computer system 602 may access the one or more databases 622 through a network 618 or may directly access the database or data repository through I/O devices and interfaces 612. The data repository storing the one or more databases 622 may reside within the computer system 402.

### CONCLUSION

In the foregoing specification, the systems and processes have been described with reference to specific implementations thereof. It will, however, be evident that various modifications and changes may be made thereto without departing from the broader spirit and scope of the implementations disclosed herein. The specification and drawings are, accordingly, to be regarded in an illustrative rather than restrictive sense.

Indeed, although the systems and processes have been disclosed in the context of certain implementations and examples, it will be understood by those skilled in the art that the various implementations of the systems and processes extend beyond the specifically disclosed implementations to other alternative implementations and/or uses of the systems and processes and obvious modifications and equivalents thereof. In addition, while several variations of the implementations of the systems and processes have been shown and described in detail, other modifications, which are within the scope of this disclosure, will be readily apparent to those of skill in the art based upon this disclosure. It is also contemplated that various combinations or sub-combinations of the specific features and aspects of the implementations may be made and still fall within the scope of the disclosure. It should be understood that various features and aspects of the disclosed implementations can be combined with, or substituted for, one another in order to form varying modes of the implementations of the disclosed systems and processes. Any methods disclosed herein need not be performed in the order recited. Thus, it is intended that the scope of the systems and processes herein disclosed should not be limited by the particular implementations described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate implementations also may be implemented in combination in a single embodiment. Conversely, various features that are described in the context of a single embodiment also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain implementations include, while other implementations do not include, certain features, elements and/or operations. Thus, such conditional language is not generally intended to imply that features, elements and/or operations are in any way required for one or more implementations or that one or more implementations necessarily include logic for deciding, with or without author input or prompting, whether these features, elements and/or operations are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the implementations are not to be limited to the particular forms or methods disclosed, but, to the contrary, the implementations are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or implementations set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the implementations shown herein but are to be accorded the widest scope consistent with this disclosure, the principles and the novel features disclosed herein.

What is claimed is:

1. A computer-implemented method for processing event data, the method comprising:
accessing a plurality of events from one or more data sources, wherein the one or more data sources comprise at least one of extended detection and response (XDR) data, endpoint detection and response (EDR) data, or security information and event management (SIEM) data,
determining an event type for each event of the plurality of events;
determining, for each event of the plurality of events, an event encoder for the event, wherein the event encoder is determined using the determined event type;
generating, for each event of the plurality of events using the determined event encoder, an event vector;
generating an input to an event collection encoder, wherein the input is based on the generated event vectors;
generating, using the event collection encoder and the input, an output embedding vector, wherein the output embedding vector is a fixed-length vector; and
providing the output embedding vector to a processing head configured for one or more of: similarity detection, anomaly detection, classification, attribution, or prioritization.

2. A computer-implemented method for processing event data, the method comprising:
accessing a plurality of events from one or more data sources;
determining an event type for each event of the plurality of events;
generating an event vector for each event of the plurality of events, wherein each event vector is generated using an event encoder selected based on the event type of the event;
generating an output embedding vector using an event collection encoder using the generated event vectors for each of the plurality of events.

3. The computer-implemented method of claim 2, wherein the plurality of events comprises a file system event, wherein the file system event comprises at least one of: a file read, a file deletion, a file creation, or a file update.

4. The computer-implemented method of claim 2, wherein the plurality of events comprises a network event, wherein the network event comprises an indication of one or more of: port number, destination, protocol, received traffic volume, or sent traffic volume.

5. The computer-implemented method of claim 2, wherein the one or more data sources comprise at least one of an endpoint detection and response (EDR) system, an extended detection and response (XDR) system, or a security information and event management (SIEM) system.

6. The computer-implemented method of claim 2, wherein the event collection encoder comprises a machine learning model, wherein the machine learning model is trained to minimize a loss function, and wherein the loss function is one of mean squared error, cross-entropy, or reconstruction loss.

7. The computer-implemented method of claim 2, wherein the event collection encoder is configurable using one or more parameters, wherein the parameters are initialized randomly or using pre-trained weights.

8. The computer-implemented method of claim 2, wherein the event collection encoder comprises a multi-level encoder.

9. The computer-implemented method of claim 2, wherein each event encoder is configured to generate embeddings having a fixed size.

10. The computer-implemented method of claim 2, wherein the event collection encoder is configured to generate output embedding vectors with a fixed size.

11. The computer-implemented method of claim 2, further comprising:
identifying a plurality of similar events from the plurality of events; and
dropping a first subset of the plurality of similar events,
wherein the first subset is not used for generating event vectors or for generating the output embedding vector.

12. The computer-implemented method of claim 11, wherein the similar events comprise network events, and wherein the similar events are determined based on a common IP address and port.

13. The computer-implemented method of claim 2, further comprising providing the output embedding vector to a processing head, wherein the processing head comprises a program configured for one or more of: similarity determination, anomaly detection, classification as malicious or benign, attribution, or prioritization.

14. A system for processing event data, the system comprising:
at least one processor; and
at least one non-transitory, computer-readable storage medium storing instructions that, when executed by the at least one processor, cause the system to:
access a plurality of events from one or more data sources;
determine an event type for each event of the plurality of events;
generate an event vector for each event of the plurality of events, wherein each event vector is generated using an event encoder selected based on the event type of the event;
generate an output embedding vector using an event collection encoder using the generated event vectors for each of the plurality of events.

15. The system of claim 14, wherein the one or more data sources comprise at least one of an endpoint detection and response (EDR) system, an extended detection and response (XDR) system, or a security information and event management (SIEM) system.

16. The system of claim 14, wherein the event collection encoder comprises a machine learning model, wherein the machine learning model is trained to minimize a loss function, and wherein the loss function is one of mean squared error, cross-entropy, or reconstruction loss.

17. The system of claim 14, wherein the event collection encoder is configurable using one or more parameters, wherein the parameters are initialized randomly or using pre-trained weights.

18. The system of claim 14, wherein the instructions are further configured to cause the system to:
identify a plurality of similar events from the plurality of events; and
drop a first subset of the plurality of similar events,
wherein the first subset is not used for generating event vectors or for generating the output embedding vector.

19. The system of claim 18, wherein the similar events comprise network events, and wherein the similar events are determined based on a common IP address and port.

20. The system of claim 14, wherein the instructions are further configured to cause the system to provide the output embedding vector to a processing head, wherein the processing head comprises a program configured for one or more of: similarity determination, anomaly detection, classification as malicious or benign, attribution, or prioritization.
